(19) United States
(12) Patent Application Publication
(10) Pub. No.: US 2015/0171505 A1
(43) Pub. Date: Jun. 18, 2015

(54) PORTABLE RADIO DEVICE HAVING EMBEDDED ANTENNA

(71) Applicant: GALTRONICS CORPORATION LTD., Tiberias (IL)

(72) Inventors: Sharon Harel, Tiberias (IL); Najed Azzam, Nazareth (IL); Matti Martiskainen, Tiberias (IL); Haim Yona, Givat Avni (IL); Yaniv Ziv, Tiberias (IL)

(73) Assignee: GALTRONICS CORPORATION LTD., Tiberias (IL)

(21) Appl. No.: 14/405,468

(22) PCT Filed: Jun. 5, 2013
(86) PCT No.: PCT/IL13/50488

§ 371 Date: Dec. 4, 2014

Related U.S. Application Data
(60) Provisional application No. 61/655,557, filed on Jun. 5, 2012.
(60) Provisional application No. 61/716,648, filed on Oct. 22, 2012.
(60) Provisional application No. 61/738,449, filed on Dec. 18, 2012.

(51) Int. Cl. H01Q 1/24

(52) U.S. Cl. CPC H01Q 1/243

(57) ABSTRACT

A portable radio device including a housing, an antenna at least partially embedded in the housing and operative to radiate in at least the VHF range and a feed arrangement for feeding the at least partially embedded antenna.

### REFERENCE TO RELATED APPLICATIONS

Reference is hereby made to U.S. Provisional Patent Application 61/655,557, entitled CONCEALED ANTENNA FOR TWO-WAY RADIO DEVICES, filed Jun. 5, 2012, to U.S. Provisional Patent Application 61/716,648, entitled WIDEBAND INTERNAL ANTENNA FOR MOBILE DEVICES AND LAND MOBILE RADIO (LMR), filed Oct. 22, 2012, and to U.S. Provisional Patent Application 61/738,449, entitled RADIO DEVICE HAVING SHAFTS FOR CONTROL THEREOF, filed Dec. 18, 2012, the disclosures of which are hereby incorporated by reference and priorities of which are hereby claimed pursuant to 37 CFR 1.78(a)(4) and (5)(i).

### FIELD OF THE INVENTION

The present invention relates generally to radio devices and more particularly to portable radio devices.

### BACKGROUND OF THE INVENTION

Various types of portable radio devices are known in the art.

### SUMMARY OF THE INVENTION

The present invention seeks to provide an embedded antenna particularly suitable for use in portable radio devices.

There is thus provided in accordance with a preferred embodiment of the present invention a portable radio device including a housing, an antenna at least partially embedded in the housing and operative to radiate in at least the VHF range and a feed arrangement for feeding the at least partially embedded antenna.

In accordance with a preferred embodiment of the present invention, the portable radio device is a land mobile radio device.

Preferably, the housing includes a cap portion and a body portion.

Preferably, the antenna is partially embedded in the housing such that a portion of the antenna extends beyond the housing.

Alternatively, the antenna is completely embedded in the housing.

Preferably, the antenna is operative to radiate in the VHF range.

In accordance with another preferred embodiment of the present invention, the antenna includes a multiband antenna.

Preferably, the antenna is operative to radiate in the 450 MHz, 750-800 MHz and VHF ranges.

In accordance with a further preferred embodiment of the present invention, the antenna includes a meander radiating element. Preferably, the antenna further includes a coil radiating element electromagnetically coupled to the meander radiating element.

Preferably, the antenna includes a first loop radiating portion, a second loose meander radiating portion and a third compact meander radiating portion.

In accordance with yet another preferred embodiment of the present invention, the portable radio device also includes a radio device chassis, the radio device chassis having a surface, at least one control knob being located on the surface, an antenna carrier mounted on the surface of the radio device chassis and overlying the at least one control knob, the antenna carrier being adapted to support the antenna, a control panel mounted on the antenna carrier and at least one control shaft extending through the antenna carrier between the at least one control knob and the control panel and adapted to allow operation of the at least one control knob at the control panel.

There is further provided in accordance with another preferred embodiment of the present invention a portable radio device including a radio device chassis, the radio device chassis having a surface, at least one control knob being located on the surface, an antenna carrier mounted on the surface of the radio device chassis and overlying the at least one control knob, a control panel mounted on the antenna carrier and at least one control shaft extending through the antenna carrier between the at least one control knob and the control panel and adapted to allow operation of the at least one control knob at the control panel.

### BRIEF DESCRIPTION OF THE DRAWINGS

The present invention will be understood and appreciated more fully from the following detailed description, taken in conjunction with the drawings in which:

FIGS. 1A, 1B, 1C and 1D are simplified respective partially assembled front and back view illustrations and assembled front and back view illustrations of a portable radio device, constructed and operative in accordance with a preferred embodiment of the present invention;

FIGS. 2A, 2B, 2C and 2D are simplified respective partially assembled front and back view illustrations and assembled front and back view illustrations of a portable radio device, constructed and operative in accordance with another preferred embodiment of the present invention;

FIG. 3A is a simplified assembled view illustration of a portable radio device, constructed and operative in accordance with yet another preferred embodiment of the present invention;

FIGS. 3B and 3C are simplified respective partially assembled front and back view illustrations of a portable radio device of the type shown in FIG. 3A; and

FIGS. 3D and 3E are simplified respective exploded and expanded assembled view illustrations of a portion of a portable radio device of the type shown in FIG. 3B.

### DETAILED DESCRIPTION OF PREFERRED EMBODIMENTS

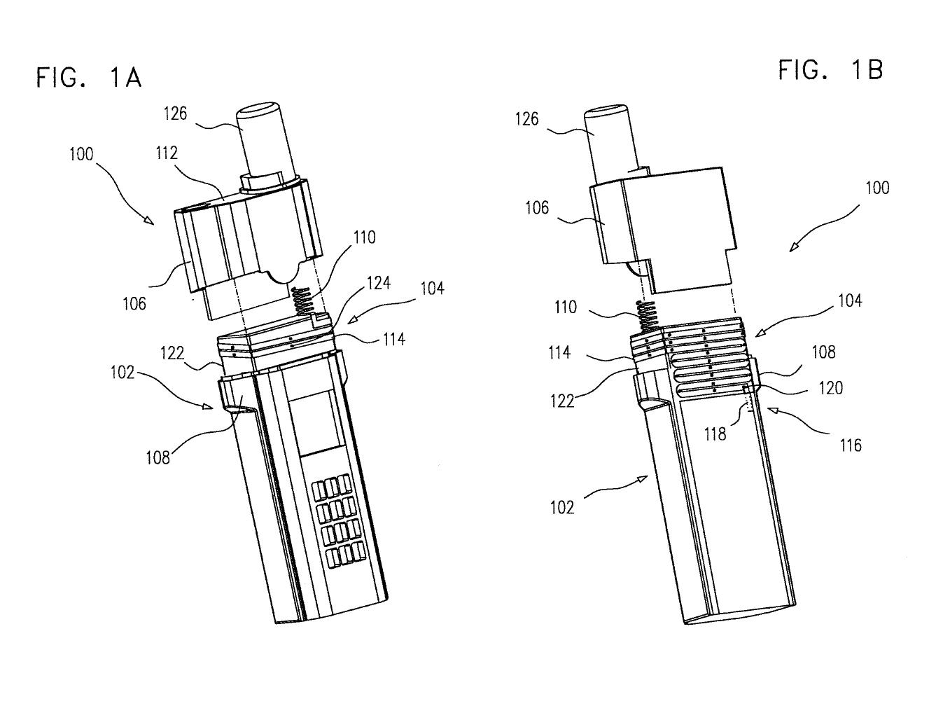

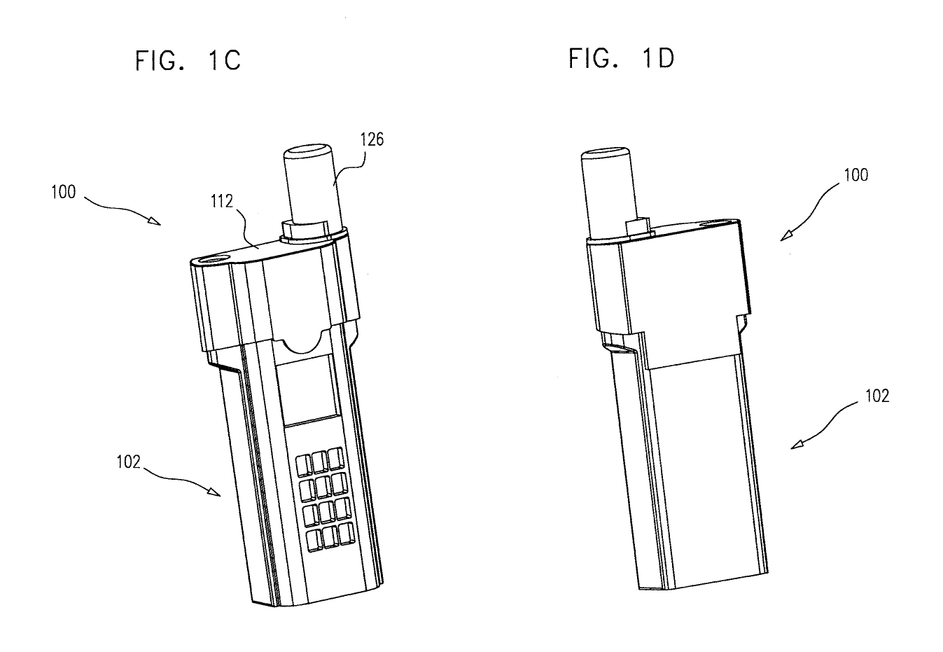

Reference is now made to FIGS. 1A, 1B, 1C and 1D, which are simplified respective partially assembled front and back view illustrations and assembled front and back view illustrations of a portable radio device, constructed and operative in accordance with a preferred embodiment of the present invention.

As seen in FIGS. 1A-1D, there is provided a portable radio device 100. Portable radio device 100 is preferably a two-way radio device and is particularly preferably a Land Mobile Radio (LMR) device. It is appreciated, however, that portable radio device 100 is in no way limited to the exemplary embodiment shown in FIGS. 1A-1D and may be embodied as one of a variety of portable radio devices having a range of different configurations.

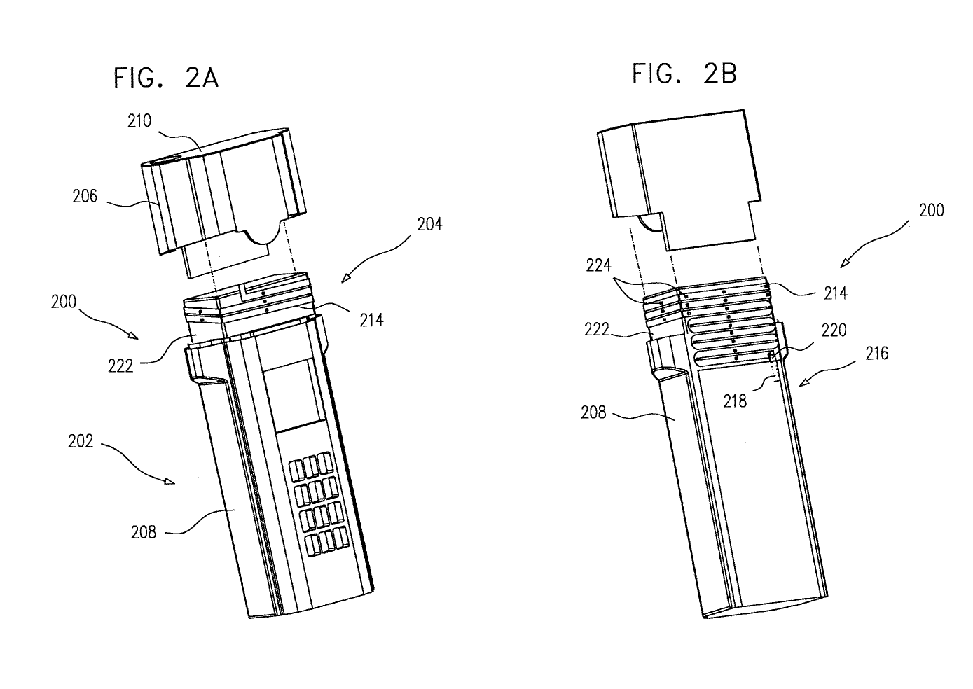

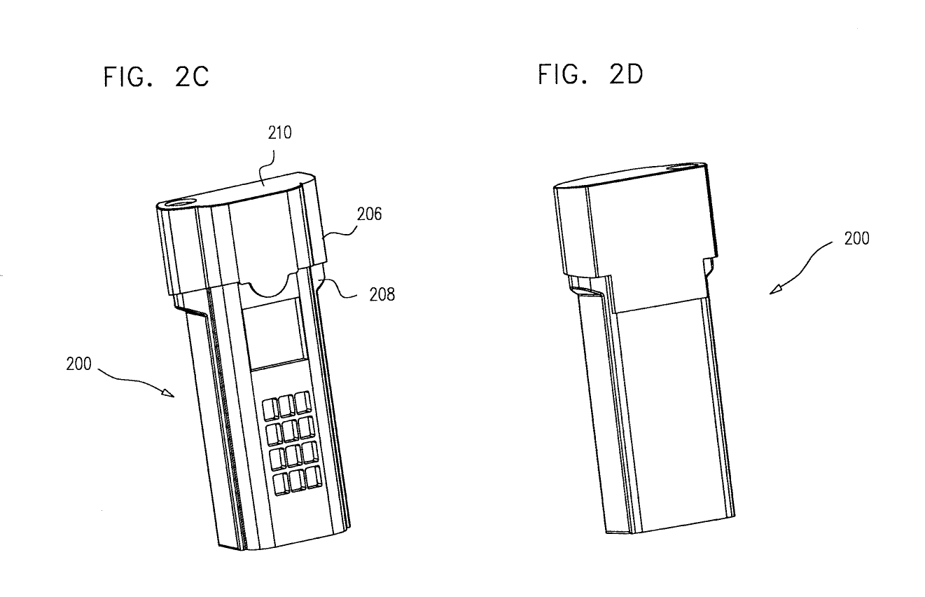

Portable radio device 100 preferably comprises a housing 102, within which housing 102 an antenna 104 is at least partially embedded. Here, by way of example, housing 102 comprises a cap portion 106 and a body portion 108. Antenna 104 is preferably partially embedded in housing 102 such that a coil element 110 of antenna 104 protrudes from an upper surface 112 of cap portion 106 and a meander element 114 of antenna 104 is concealed by housing 102, when radio device 100 is in its assembled state. Alternatively, antenna 104 may be completely embedded within housing 102, such that antenna 104 does not significantly extend beyond upper surface 112 of housing 102, as will be detailed henceforth with reference to FIGS. 2A-2D.

It is appreciated that the illustrated embodiment of housing 102 comprising two distinct elements, namely cap portion 106 and body portion 108, is exemplary only and that housing 102 may alternatively be formed as a monolithic element. It is further appreciated that references herein to the front and back of radio device 100 are relational and exemplary only and that the location and orientation at which antenna 104 is partially embedded in radio device 100 may be varied, without departing from the scope of the present invention.

Antenna 104 is preferably operative to radiate in at least the Very High Frequency (VHF) range, spanning approximately 30-300 MHz. Here, by way of example, antenna 104 is operative to radiate in the 136-174 MHz frequency range and thus to allow radio device 100 to transmit and receive in this frequency range. It is a particular feature of a preferred embodiment of the present invention that radio device 100 is capable of communicating in the VHF range by way of partially embedded antenna 104, thereby obviating the need for a relatively large external antenna typically appended to portable radio devices so as to allow communication in the VHF range. The partially embedded configuration of antenna 104 allows antenna 104 to extended approximately 4-7 cm beyond upper surface 112 of housing 102. This is in contrast to conventional external antennas typically employed in two-way radio devices for communication in the VHF range, which external antennas tend to extend at least 20 cm beyond an upper surface of the device.

The partially embedded configuration of antenna 104 confers a number of significant advantages on portable radio device 100, including reduction of overall size of portable radio device 100, improved mechanical stability and enhanced aesthetic appeal in comparison to conventional portable radio devices having relatively large external antennas for communication in the VHF range.

Antenna 104 preferably comprises coil radiating element 110 and meander radiating element 114 preferably connected thereto. In the embodiment of radiating element 104 illustrated in FIGS. 1A-1D coil element 110 is shown to be galvanically connected to meander element 114. It is appreciated, however, that coil element 110 may alternatively be non-galvanically connected to meander element 114, provided that coil element 110 remains electromagnetically coupled to meander element 114. It is further appreciated that coil element 110 may alternatively be obviated, such that the radiating part of antenna 104 essentially comprises only meander element 114, as will be detailed henceforth with reference to FIGS. 2A-2D.

As seen most clearly in FIG. 1B, antenna 104 is preferably fed by a feed arrangement 116, which feed arrangement 116 preferably comprises a conductive feedline 118 preferably extending between an end point 120 of meander element 114 and a signal input point (not shown). A matching network (not shown) is preferably incorporated into feed arrangement 116 in order to match an impedance of antenna 104 to an impedance of the signal input point, thereby maximizing energy transfer therebetween. A broadband matching network, such as that disclosed in PCT application no. PCT/IL2013/050263, assigned to the same assignee as the present invention, has been found to be particularly well-suited for this purpose. It is appreciated, however, that antenna 104 may alternatively be fed by way of any appropriate feed arrangement known in the art and capable of providing matching between antenna 104 and a signal source.

Meander element 114 is preferably supported by a non-conductive carrier 122, which carrier 122 is preferably adapted for insertion into body portion 108 of the housing 102. Carrier 122 is preferably embodied as a rigid plastic part to which meander element 114 is preferably attached at intervals therealong by way of a multiplicity of non-conductive heat stakes 124. It is appreciated that the particular configuration of carrier 122 shown in FIGS. 1A and 1B is exemplary only and that carrier 122 may have a variety of two or three dimensional topologies adapted to support antenna 104 and suitable for integration into housing 102 of radio device 100.

A protective cover 126, preferably extending from upper surface 112 of cap portion 106, may optionally be included in radio device 100 so as to conceal coil element 110 and thus prevent damage thereto during operation of radio device 100.

It is appreciated that radio device 100 is shown in a simplified form in FIGS. 1A-1D for the sake of clarity of presentation. Radio device 100 may be modified to include a range of additional features as are well known in the art, including, by way of example, an external case, a key pad and additional control knobs.

Reference is now made to FIGS. 2A, 2B, 2C and 2D, which are simplified respective partially assembled front and back view illustrations and assembled front and back view illustrations of a portable radio device, constructed and operative in accordance with another preferred embodiment of the present invention.

As seen in FIGS. 2A-2D, there is provided a portable radio device 200. Portable radio device 200 is preferably a two-way radio device and is particularly preferably an LMR device. It is appreciated, however, that portable radio device 200 is in no way limited to the exemplary embodiment shown in FIGS. 2A-2D and may be embodied as one of a variety of portable radio devices having a range of different configurations.

As seen most clearly in FIGS. 2A and 2B, portable radio device 200 preferably comprises a housing 202, within which housing 202 an antenna 204 is at least partially embedded. Here, by way of example, housing 202 comprises a cap portion 206 and a body portion 208. Antenna 204 is preferably completely embedded in housing 202 such that antenna 204 is concealed by housing 202 and does not extend beyond an upper surface 210 of cap portion 206 when radio device 200 is in its assembled state.

It is appreciated that the illustrated embodiment of housing 202 comprising two distinct elements, namely cap portion 206 and body portion 208, is exemplary only and that housing 202 may alternatively be formed as a monolithic element. It is further appreciated that references herein to the front and back of radio device 200 are relational and exemplary only and that the location and orientation at which antenna 204 is embedded in radio device 200 may be varied, without departing from the scope of the present invention.

Antenna 204 is preferably operative to radiate in at least the Very High Frequency (VHF) range, spanning approximately 30-300 MHz. Here, by way of example, antenna 204 is operative to radiate in the 136-174 MHz frequency range and thus to allow radio device 200 to transmit and receive in this frequency range. It is a particular feature of a preferred embodiment of the present invention that radio device 200 is capable of communicating in the VHF range by way of embedded antenna 204, thereby obviating the need for a relatively large external antenna typically appended to portable radio devices in order to allow communication in the VHF range. The internal placement of antenna 204 is in contrast to the conventional configuration of external antennas typically employed in two-way radio devices for communication in the VHF range, which external antennas tend to extend at least 20 cm beyond an upper surface of the device.

The embedded configuration of antenna 204 confers a number of significant advantages on portable radio device 200, including reduction of overall size of portable radio device 200, improved mechanical stability and enhanced aesthetic appeal in comparison to conventional portable radio devices having relatively large external antennas for communication in the VHF range.

Antenna 204 is preferably formed by a meander radiating element 214, which meander radiating element 214 is preferably fed by a feed arrangement 216. Feed arrangement 216 preferably comprises a conductive feedline 218 preferably extending between an end point 220 of meander element 214 and a signal input point (not shown). A matching network (not shown) is preferably incorporated into feed arrangement 216 in order to match an impedance of antenna 204 to an impedance of the signal input point, thereby maximizing energy transfer therebetween. A broadband matching network, such as that disclosed in PCT application no. PCT/IL2013/050263, assigned to the same assignee as the present invention, has been found to be particularly well-suited for this purpose. It is appreciated, however, that antenna 204 may alternatively be fed by any appropriate feed arrangement known in the art and capable of providing acceptable matching of antenna 204 to a signal source.

Meander element 214 is preferably supported by a non-conductive carrier 222, which carrier 222 is preferably adapted for insertion into body portion 208 of radio device 200. Carrier 222 is preferably embodied as a rigid plastic part to which meander element 214 is preferably attached at intervals therealong by way of a multiplicity of non-conductive heat stakes 224. It is appreciated that the particular configuration of carrier 222 shown in FIGS. 2A and 2B is exemplary only and that carrier 222 may have a variety of two or three dimensional topologies adapted to support antenna 204 and suitable for integration into housing 202 of radio device 200. It is further appreciated that radio device 200 is shown in a simplified form in FIGS. 2A-2D for the sake of clarity of presentation. Radio device 200 may be modified to include a range of additional features as are well known in the art, including, by way of example, an external case, a key pad and additional control knobs.

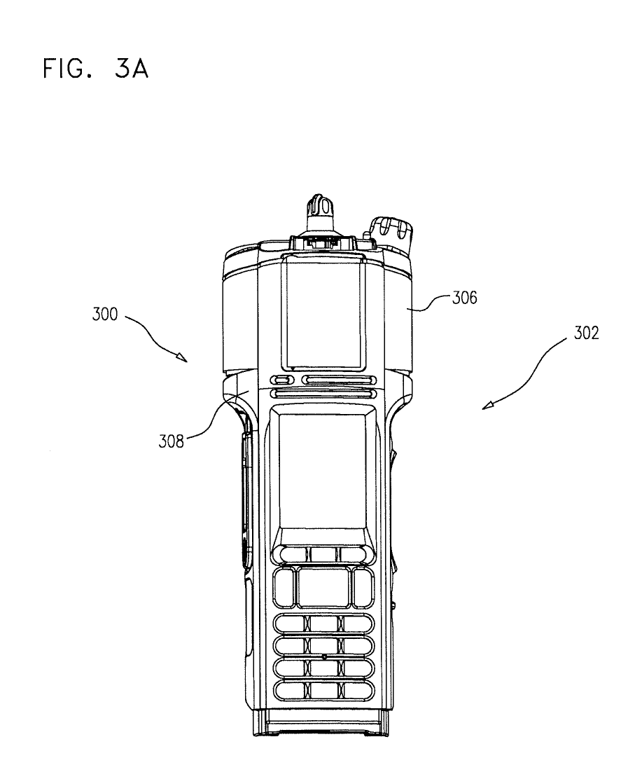

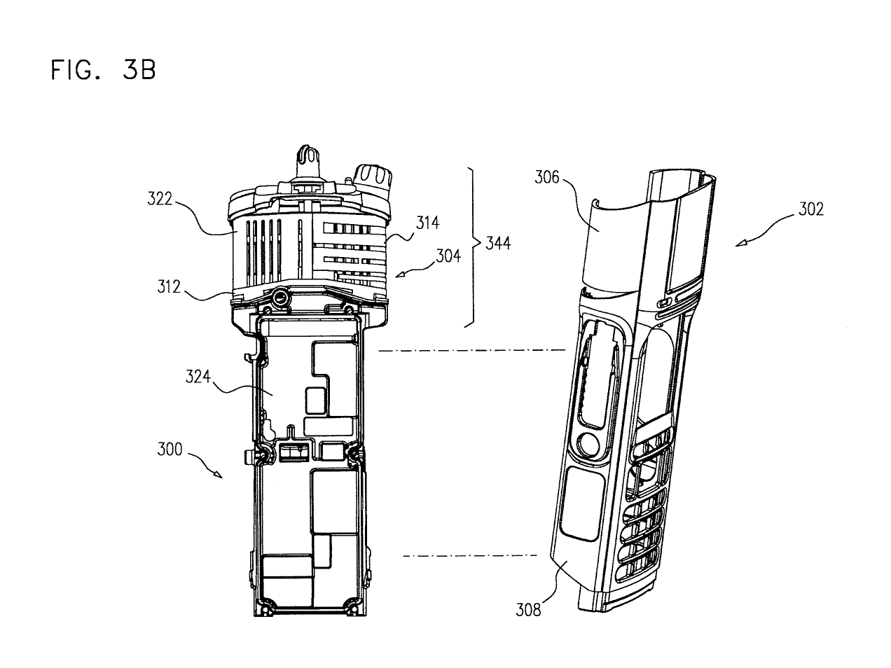

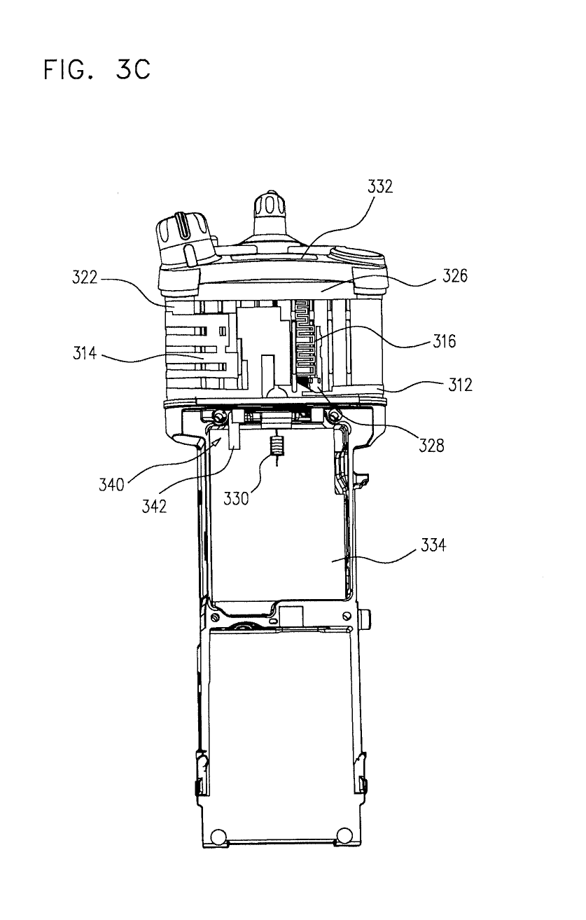

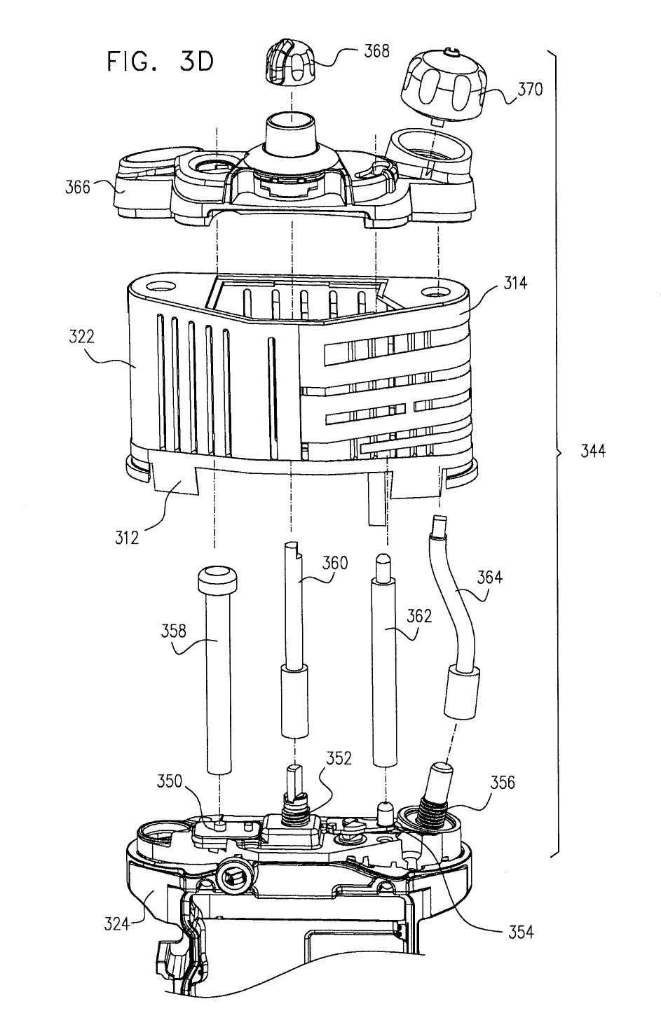

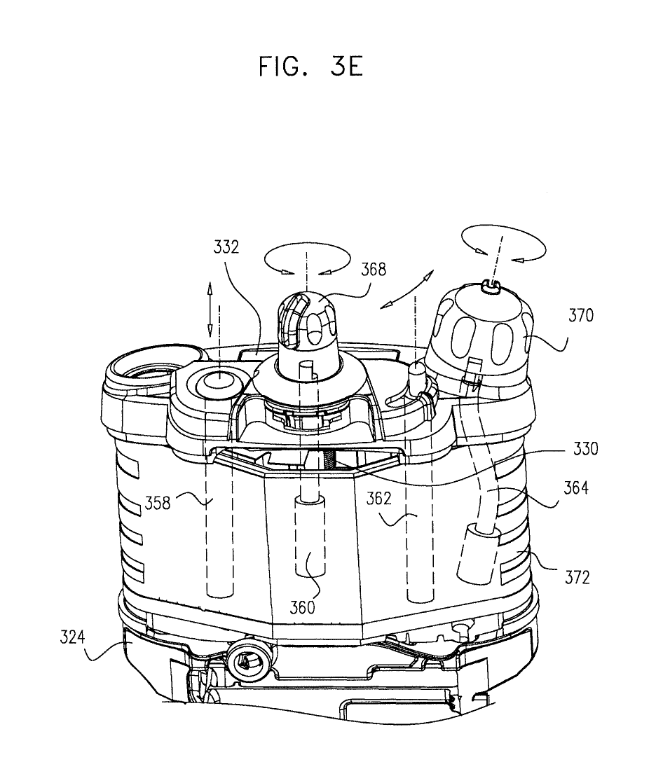

Reference is now made to FIG. 3A, which is a simplified assembled view illustration of a portable radio device, constructed and operative in accordance with yet another preferred embodiment of the present invention, and to FIGS. 3B and 3C, which are simplified respective partially assembled front and back view illustrations thereof.

As seen in FIGS. 3A-3C, there is provided a portable radio device 300. Portable radio device 300 is preferably a two-way radio device and is particularly preferably an LMR device. It is appreciated, however, that portable radio device 300 is in no way limited to the exemplary embodiment shown in FIGS. 3A-3C and may be embodied as one of a variety of portable radio devices having a range of different configurations.

As seen most clearly in FIGS. 3A and 3B, portable radio device 300 preferably comprises a housing 302, within which housing 302 an antenna 304 is at least partially embedded. Here, by way of example, housing 302 comprises an upper portion 306 and a lower portion 308 formed integrally therewith. Antenna 304 is preferably completely embedded in housing 302 such that antenna 304 is concealed by housing 302 and does not extend beyond housing 302 when radio device 300 is in its assembled state.

It is appreciated that the illustrated embodiment of housing 302 comprising a single monolithic element is exemplary only and that housing 302 may alternatively comprise a number of discrete elements. It is further appreciated that references herein to the front and back of radio device 300 are relational and exemplary only and that the location and orientation at which antenna 304 is embedded in radio device 300 may be varied, without departing from the scope of the present invention.

Antenna 304 is preferably operative to radiate in at least the Very High Frequency (VHF) range, spanning approximately 30-300 MHz. Here, by way of example, antenna 304 is a multiband antenna, preferably capable of radiating in the 450 MHz, 700-800 MHz and VHF ranges. It is a particular feature of a preferred embodiment of the present invention that radio device 300 is capable of communicating in the VHF range by way of embedded antenna 304, thereby obviating the need for a relatively large external antenna typically appended to portable radio devices in order to allow communication in the VHF range. The internal placement of antenna 304 is in contrast to the conventional configuration of external antennas typically employed in two-way radio devices for communication in the VHF range, which external antennas tend to extend at least 20 cm beyond an upper surface of the device.

The embedded configuration of antenna 304 gives rise to a number of significant advantages in portable radio device 300, including reduction of overall size of portable radio device 300, improved mechanical stability and enhanced aesthetic appeal in comparison to conventional portable radio devices having relatively large external antennas for communication in the VHF range.

As seen most clearly in FIGS. 3B and 3C, antenna 304 preferably comprises a first loop radiating portion 312, a second loose meander radiating portion 314 and a third compact meander radiating portion 316. It is appreciated that although first, second and third portions 312, 314 and 316 are distinguished between herein for the purpose of description of their respective individual functions, some or all of first, second and third portions 312, 314 and 316 may be formed as a monolithic structure.

Antenna 304 is preferably supported by a non-conductive carrier 322, which carrier 322 is preferably mounted on a chassis 324. Carrier 322 is preferably embodied as a rigid plastic part on which antenna 304 is preferably mounted. It is appreciated that the particular configuration of carrier 322 shown in FIGS. 3B and 3C is exemplary only and that carrier 322 may have a variety of two or three dimensional topologies, providing that carrier 322 may be integrated into housing 302.

First loop radiating portion 312 preferably comprises a loop structure encircling a base of carrier 322. First loop radiating portion 312 is preferably juxtaposed to chassis 324 so as to facilitate electromagnetic coupling therebetween. In operation of antenna 304, first loop radiating portion 312 is preferably operative to provide coupling to chassis 324, whereby chassis 324 in combination with first loop radiating portion 312 radiates in the 450 MHz range.

Second loose meander radiating portion 314 is preferably contiguous with first loop radiating portion 312 and terminates in a ring-like structure 326 partially encircling an upper section of carrier 322. Second loose meander radiating portion 314 preferably has an electrical length so as to support radiation in the 750-800 MHz range. In addition to acting as a radiating element in its own right, first loop radiating portion 312 preferably serves as a transmission line feeding second loose meander radiating portion 314.

First loop radiating portion 312, second loose meander portion 314 and third compact meander portion 316 preferably form a composite radiating element having sufficient combined electrical length so as to radiate in a frequency range preferably spanning 136-174 MHz. In the embodiment of antenna 304 illustrated in FIG. 3C third compact meander portion 316 is illustrated as being formed on a dedicated printed circuit board (PCB) 328, which PCB 328 bridges ring-like structure 326 and first loop radiating portion 312. It is appreciated, however, that the formation of third compact meander portion 316 on dedicated PCB 328 is exemplary only and that PCB 328 may alternatively be obviated.

A pair of inductive elements 330, here preferably embodied as a pair of coils, is preferably provided between a screen 332 of radio device 300 and an internal PCB 334. The presence of inductive elements 330 serves to isolate screen 332 and internal PCB 334 from antenna 304 and thereby prevent undesirable coupling therebetween.

As seen most clearly in FIG. 3C, antenna 304 is preferably fed by a feed arrangement 340. Feed arrangement 340 preferably comprises a conductive feedline 342 preferably extending between an intermediate point of first loop radiating portion 312 and a signal input point (not shown). A matching network (not shown) is preferably incorporated into feed arrangement 340 in order to match an impedance of antenna 304 to an impedance of the signal input point, thereby maximizing energy transfer therebetween. A broadband matching network, such as that disclosed in PCT application no. PCT/IL2013/050263, assigned to the same assignee as the present invention, has been found to be particularly well-suited for this purpose. It is appreciated, however, that antenna 304 may alternatively be fed by way of any appropriate feed arrangement known in the art and capable of providing acceptable matching of antenna 304 to a signal source.

Reference is now made to FIGS. 3D and 3E, which are simplified respective exploded and expanded assembled view illustrations of a portion 344 of a portable radio device of the type shown in FIG. 3B.

As seen in FIGS. 3D and 3E, chassis 324 preferably has at least one control knob located on a surface thereof, here embodied, by way of example, as four control knobs 350, 352, 354 and 356. Antenna carrier 322 preferably overlies control knobs 350-356 when radio device 300 is in its assembled state, thereby preventing access to and operation of control knobs 350-356 but for the provision of at least one control shaft, here embodied, by way of example, as a plurality of control shafts 358, 360, 362 and 364. Control shafts 358-364 respectively extend through carrier 322 and between control knobs 350-356 and a control panel 366 of radio device 300. Control shafts 358-364 thereby effectively extend the function of control knobs 350-356 to control panel 366 of radio device 300 and thus allow operation of control knobs 350-356 at control panel 366 of radio device 300. Were it not for the provision of control shafts 358-364, antenna carrier 322 would obscure control knobs 350-356 and hence prevent the operation thereof.

It is a particular feature of a preferred embodiment of the present invention that control shafts 358-364 preferably comprise a material that does not interfere with the radio-frequency performance of antenna 304. Control shafts 358-364 preferably comprise a non-conductive, low-loss dielectric material such as a polymer. Control shafts 358-364 are preferably respectively configured so as to have geometries compatible with the surface features of respective control knobs 350-356. It is appreciated that the particular configurations of control shafts 358-364 shown in FIGS. 3D and 3E are exemplary only and that control shafts 358-364 may alternatively be configured so as to co-operate with a variety of other possible shapes and sizes of control knobs 350-356.

As seen most clearly in FIG. 3E, control shafts 358-364 may extend through control panel 366 and thereby be operated directly by a user, as shown, by way of example, in the case of control shafts 358 and 362. Additionally or alternatively, control shafts 358-364 may terminate in external control features, such as dials 368 and 370, respectively preferably located atop of control shafts 360 and 364. As indicated in FIG. 3E, dials 368 and 370 are preferably operated by way of rotation whereas control shaft 358 is preferably operated by pushing up and down and control shaft 362 is preferably operated by way of sliding. It is appreciated, however, that the illustrated operation of control knobs 350-356, and by extrapolation that of control shafts 358-364, is exemplary only and that control knobs 350-356 and hence control shafts 358-364 may be operated by way of one or more of rotation, pressing, sliding or any other appropriate method of manipulation.

It is further appreciated that although control knobs 350-356 and associated control shafts 358-364 for control thereof have been described with reference to portable radio device 300, control shafts generally similar to control shafts 358-364 may be adapted for implementation in other embodiments of the present invention, such as in radio devices 100 and 200, in order to extend the function of control knobs located on an internal surface of a portable radio device to an external surface of the radio device.

As seen most clearly in FIG. 3E, antenna carrier 322 is optionally enclosed by a protective cover 372 when radio device 300 is in its assembled state. It is appreciated, however, that protective cover 372 may alternatively be obviated, depending on the design requirements of radio device 300.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A portable radio device comprising:
a housing;
an antenna at least partially embedded in said housing and operative to radiate in at least the VHF range; and
a feed arrangement for feeding said at least partially embedded antenna.

2. A portable radio device according to claim 1, wherein said portable radio device is a land mobile radio device.

3. A portable radio device according to claim 1, wherein said housing comprises a cap portion and a body portion.

4. A portable radio device according to claim 1, wherein said antenna is partially embedded in said housing such that a portion of said antenna extends beyond said housing.

5. A portable radio device according to claim 1, wherein said antenna is completely embedded in said housing.

6. A portable radio device according to claim 5, wherein said antenna is operative to radiate in the VHF range.

7. A portable radio device according to claim 5, wherein said antenna comprises a multiband antenna.

8. A portable radio device according to claim 7, wherein said antenna is operative to radiate in the 450 MHz, 750-800 MHz and VHF ranges.

9. A portable radio device according to claim 5, wherein said antenna comprises a meander radiating element.

10. A portable radio device according to claim 9, wherein said antenna further comprises a coil radiating element electromagnetically coupled to said meander radiating element.

11. A portable radio device according to claim 7, wherein said antenna comprises a first loop radiating portion, a second loose meander radiating portion and a third compact meander radiating portion.

12. A portable radio device according to claim 1, and also comprising:
a radio device chassis, said radio device chassis having a surface, at least one control knob being located on said surface;
an antenna carrier mounted on said surface of said radio device chassis and overlying said at least one control knob, said antenna carrier being adapted to support said antenna;
a control panel mounted on said antenna carrier; and
at least one control shaft extending through said antenna carrier between said at least one control knob and said control panel and adapted to allow operation of said at least one control knob at said control panel.

13. A portable radio device comprising:
a radio device chassis, said radio device chassis having a surface, at least one control knob being located on said surface;
an antenna carrier mounted on said surface of said radio device chassis and overlying said at least one control knob;
a control panel mounted on said antenna carrier; and
at least one control shaft extending through said antenna carrier between said at least one control knob and said control panel and adapted to allow operation of said at least one control knob at said control panel.

14. A portable radio device according to claim 2, wherein said housing comprises a cap portion and a body portion.

15. A portable radio device according to claim 4, wherein said antenna is operative to radiate in the VHF range.

16. A portable radio device according to claim 4, wherein said antenna comprises a multiband antenna.

17. A portable radio device according to claim 16, wherein said antenna is operative to radiate in the 450 MHz, 750-800 MHz and VHF ranges.

18. A portable radio device according to claim 4, wherein said antenna comprises a meander radiating element.

19. A portable radio device according to claim 18, wherein said antenna further comprises a coil radiating element electromagnetically coupled to said meander radiating element.

20. A portable radio device according to claim 16, wherein said antenna comprises a first loop radiating portion, a second loose meander radiating portion and a third compact meander radiating portion.
